(19) United States
(12) Patent Application Publication
(10) Pub. No.: US 2009/0238421 A1
(43) Pub. Date: Sep. 24, 2009

(54) IMAGE NORMALIZATION FOR COMPUTER-AIDED DETECTION, REVIEW AND DIAGNOSIS

(75) Inventors: Heidi Daoxian Zhang, Los Gatos, CA (US); Patrick Bernard Heffernan, Los Gatos, CA (US)

Correspondence Address: Three Palm Software LLC, 367 Penn Way, Los Gatos, CA, 95032, US

(73) Assignee: THREE PALM SOFTWARE, Los Gatos, CA (US)

(21) Appl. No.: 12/050,911

(22) Filed: Mar. 18, 2008

(51) Int. Cl. G06K 9/00

(52) U.S. Cl. 382/128

(57) ABSTRACT

A method and apparatus for processing medical images from one of a plurality of digital acquisition modalities or manufacturers with different imaging condition is proposed for creating consistent appearance of the images. The method comprises (1) tissue segmentation to isolate the region of interest; (2) dynamic extraction of the optimal parameters for image transformation from the segmented region; (3) generation of a transformation function from the individual image optimized parameters; and (4) use of the transformation function to produce images that have consistent image characteristics. This method also applies to multiple images from a single study or multiple studies. The transformed images can be used for computer-aided lesion detection, review and diagnosis.

### CROSS-REFERENCE TO RELATED APPLICATIONS

### U.S. Patent Documents

U.S. Pat. No. 7,072,498 B1 July 2006 Roehrig et al. “Method and apparatus for expanding the use of existing computer-aided detection code”

U.S. Pat. No. 6,584,216 B1 June 2003 Nyl et al. “Method for standardizing the MR image intensity scale”

U.S. Pat. No. 6,483,933 B1 November 2002 Shi et al. “Digital-to-film radiographic image conversion including a network”

U.S. 60/906,304 March 2007 “Image normalization for computer-aided detection, review and diagnosis”

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to the field of medical imaging analysis. Particularly, the present invention relates to a method and system for utilizing image normalization algorithms in conjunction with computer-aided detection, review and diagnosis (CAD).

The applicable U.S. patent Classification Definitions: 382/168 (class 382, Image Analysis, subclass 168 Histogram Processing); 382/274 (class 382, Image Analysis, subclass 274 Intensity, brightness, contrast or shading correction).

The medical images, such as, X-ray mammography images, are obtained from different modalities, different acquisition devices, and often from different exposure conditions. The modality can be digitized analog films, FFDM (full field digital mammography), or CR for mammography. The acquisition devices can be from different manufacturers or different releases from a single manufacturer. The patient tissue density, the size of the imaging target or imaging protocol may introduce different exposure conditions. Therefore the image appearance is very different, for example, the breast border area is too dark to visualize the skin line on digitized film images, or images appear to be flat white from raw FFDM images. All these differences make it difficult for radiologists to review images efficiently and effectively and also make it difficult for a CAD algorithm to produce consistent performance results. Thus image normalization technology is usually applied to make images appear relatively consistent or “standard”.

Conventional normalization methods (listed in the reference section) typically use a calibration design or a standard histogram of the image to produce a set of fixed lookup tables to transform image to a “standard canonical” form. However even within the same modality and same acquisition device, the image characteristics can be quite different from different exposure conditions and from different patient tissue density. So a single set of fixed lookup tables for image transformation is not sufficiently robust to produce consistent image appearance for all images. Therefore it is desirable to develop an image normalization algorithm based on individual image characteristics, where the optimal transformation parameters are generated dynamically.

### BRIEF SUMMARY OF THE INVENTION

The conventional normalization methods attempt to normalize images from one modality to another modality. For example, in mammography CAD, normalization is usually applied to the digital FFDM or CR images to make their appearance look like digitized film images. The disadvantage of this normalization direction is that it may lose important information in the digital images, such as, skin line at low film OD (optical density) range. This invention proposes a method that normalizes the images from different modalities to a pseudo-modality so that the detailed image pixel characteristics from different modalities are kept. This also results in a uniform and enlarged pseudo-modality image database which contains cases from many modalities and many acquisition manufacturers. This should help with the training of a CAD system to handle detection and diagnosis tasks more robustly.

The image normalization algorithm basically includes four steps to transform images: (1) tissue segmentation to derive a region of interest; (2) dynamic extraction of the optimal parameters for image transformation from the segmented region; (3) generation of a transformation function using the individual image optimized parameters; and (4) application of that transformation function to the particular source images to produce images that have consistent image characteristics. This method also applies to multiple images from a single study, such as, standard 4 images of 2 views and 2 breasts from a screening mammogram exam; or from multiple studies, such as, current digital study and prior analog study.

The transformation functions above are comprised of two parts: histogram-based transformation followed by enhancement of any over-exposed areas. The histogram-based transformation is performed by extracting parameters of the transformation function so that the transformed images have the same pixel dynamic range and statistical characteristics as images in the pseudo-modality. The transformation parameters can be the histogram center and standard deviation for each tissue density range. In mammography, the pectoral tissue and breast tissue areas are processed separately. Within the breast tissue, four density patterns are defined in BI-RADS. The over-exposed areas in X-ray images usually refer to the dark area in the images, such as, close to the skin line in digitized film images.

### BRIEF DESCRIPTION OF THE SEVERAL VIEWS OF THE DRAWING

FIG. 1 is a block diagram of the high level flow-chart for Image normalization.

FIG. 2 is a block diagram o the low level flow-chart for the transform generation function.

### DETAILED DESCRIPTION OF THE INVENTION

The method of the present invention analyzes individual image characteristics, generates transformation parameters dynamically in an optimized manner, and applies the generated transform to normalize images as they were acquired from a consistent pseudo-modality.

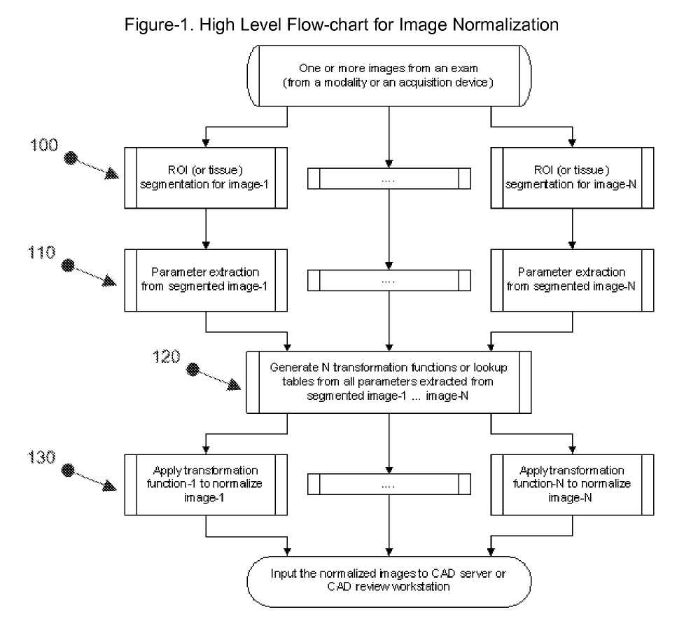

Referring to FIG. 1, a block diagram of the high level flow-chart for image normalization starts from inputting one or more images from an exam and sometime plus from another exam of the same patient that was taken previously.

In step 100, segmentation to obtain a region of interest, which usually is a body part, such as breast tissue inside breast border.

In step 110, a set of image characteristic parameters, such as, mean and standard deviation, for each image are extracted from the region of interest in each image.

In step 120, all sets of parameters from all images are processed to obtain a set of optimal parameters for each image transformation function.

In step 130, the transformation function for each image is generated using the individual optimized parameters; and finally apply the individual transformation function to the particular source images to produce the normalized images that have consistent image appearances.

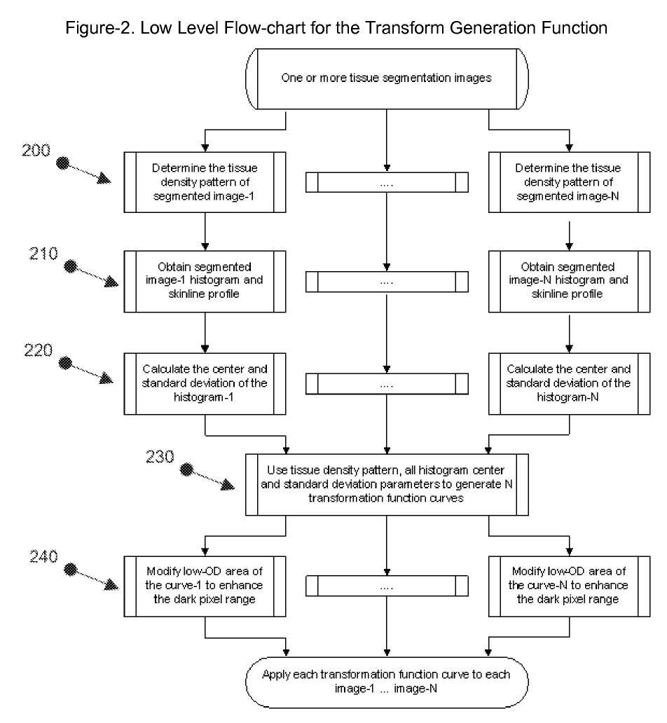

Referring to FIG. 2, a block diagram of the low level flow-chart for generating the transform function from the tissue segmentation images.

In step 200, within tissue segmented region of interest, four to five density patterns are determined based on BIRADS: 1. fat density (<25% glandular); 2. scattered fibroglandular density (25-50% glandular); 3. heterogeneously dense density (51-75% glandular); 4. extremely dense density (>75% glandular); and 5. pectoral muscle region if exists in MLO views. The 100% glandular is mapped to full dynamic range of image pixel value.

In step 210, histogram is obtained from each determined density pattern region and skin profile is also obtained from tissue segmentation.

In step 220, parameters of mean and standard deviation of each histogram are calculated.

In step 230, use histogram equivalent transformation to calculate optimal parameters:

define mean and standard deviation parameters for pseudo-modality image for each density pattern;

calculate average of mean and deviation from all histogram;

calculate the difference between the average and the defined pseudo-modality of determined density pattern;

generate new mean and standard deviation for by adding the difference to mean and deviation of each histogram;

obtain the transform function to convert the image that its histogram should generate same value as new mean and new standard deviation.

So this histogram-based transformation is performed by extracting parameters of the transformation function so that the transformed images have the same pixel dynamic range and statistical characteristics as images in the pseudo-modality.

In step 240, update the transform function to enhance any over-exposed areas (such as sigmoid transform). The over-exposed areas in X-ray images usually refer to the dark area in the images, such as, close to the skin line in digitized film images.

Finally apply each transform function to each image to normalize all images in this set.

We claim:

1. A method to analyze a group of medical images obtained from a plurality of digital acquisition modalities or a plurality of manufacturers or a plurality of imaging conditions, such that the produced images have consistent image characteristics and consistent appearance, which comprises steps of:
segmenting tissue to isolate the region of interest;
extracting the optimal parameters from the segmented region;
generating transformation function from the optimized parameters;
producing images using of the transformation function.

2. The method of claim 1, wherein the extracting the optimal parameters from the segmented region comprises steps of:
calculating density pattern of the segmented region;
calculating histogram of each segmented region;
calculating mean and standard deviation of each histogram;
calculating average of mean and deviation from all histograms;
calculating the difference between the average and the defined pseudo-modality of determined density pattern;
calculating new mean and standard deviation for by adding the difference to mean and deviation of each histogram;
calculating the transform function as the histogram has the same value as new mean and new standard deviation.
